(19) United States
(12) Patent Application Publication
(10) Pub. No.: US 2006/0105693 A1
(43) Pub. Date: May 18, 2006

(54) Coin and/or token dispenser for automatic distributors or paying devices

(75) Inventor: Fabrizio Rigo, Bologna (IT)

Correspondence Address: WILLIAM J. SAPONE;COLEMAN SUDOL SAPONE P.C., 714 COLORADO AVENUE, BRIDGE PORT, CT, 06605, US

(73) Assignee: HOPPER S.R.L., Bologna (IT)

(21) Appl. No.: 11/248,444

(22) Filed: Oct. 11, 2005

(30) Foreign Application Priority Data
Oct. 13, 2004 (IT) BO2004A 000624
Feb. 2, 2005 (IT) BO2005A 000051

(51) Int. Cl. G07D 1/00

(52) U.S. Cl. 453/47

(57) ABSTRACT

A coin and/or token dispenser for automatic distributors or paying devices, has a chamber for receiving and storing coins and/or tokens. A rotating disc is mounted on a first inner wall of the chamber and is connected to a motor situated outside the chamber. The disc has a plurality of rows of protruding teeth, situated on a surface of the disc turned to the inside of the chamber, for moving the coins and/or tokens along a circular path. A coin deflecting member is cantilevered to a second inner wall of the chamber above a circular section of the disc and has a plurality of circular recesses which can house freely the protruding teeth and make them translate thereinside. An elastic member is situated external to the rotating disc, on the same first inner wall, near the deflecting member, and receives the deflected coins and/or tokens and sends them to an outlet slot order to deliver them.

### FIELD OF THE INVENTION

The present invention relates to coin and/or token dispensers, which are installed in the automatic distributors of goods and/or services, to give coins as balance, or in the payment devices and coin changers, or in the slot machines.

The dispensers are aimed at receiving and storing coins thereinside, generally coins of the same kind and value, and/or tokens, and at dispensing a pre-established quantity thereof, when specifically requested or after the delivery of goods or services by the relevant automatic distributor.

### BRIEF DESCRIPTION OF THE PRIOR ART

Known dispensers include a chamber, for receiving or storing coins or tokens coming from a storing magazine, usually frusto-conical shaped with the base inclined and with a lateral inner wall provided with a rotating disc.

The rotating disc is connected, by suitable coupling means, e.g. a gear, to a motor means, situated outside the magazine chamber. The rotating disc has a working surface, facing the inside of the chamber and the mass of coins or tokens present therein.

The working surface of the rotating disc has means for conveying single coins or single tokens, when the rotating disc is set into rotation by the motor, to a deflecting member, cantilevered to a lateral wall of the magazine chamber above a circular section of the working surface of the rotating disc, so as to deflect the coins or tokens toward an outlet slot, situated on a dispenser lateral wall.

In a first type of known dispensers, the conveying means include a series of single prongs, which are arranged one after another along a circumference situated on the working surface of the disc, concentrically therewith.

The prongs are arranged along the circumference, spaced apart in such a way, as to receive therebetween respective single coins or tokens and to move them, during the disc rotation, toward the deflecting member to dispense the coins or tokens through the outlet slot.

This type of dispenser has different disadvantages.

First of all, if the dispensers are used for dispensing coins or tokens of small dimensions, the prongs cannot hold the coins or tokens and pull them toward the deflecting member.

Moreover, it often happens that more coins or tokens enter the same space between two adjacent prongs, which results in an incorrect delivery of the prefixed quantity of coins or tokens.

Further, it has happened that the delivery of coins or tokens was interrupted because the latter have got stuck between the prongs and the deflecting member.

In a second type of dispensers, the conveying means include a series of retractable walls, mounted in a region corresponding to the related slots, made radially along relevant radiuses of the working surface of the rotating disc and regularly spaced apart.

The radial walls define, therebetween, a kind of seat, which receives thereinside any kind of coins or tokens, of minimum as well as of maximum diameter.

The above mentioned walls are mounted on corresponding spring means, which are introduced into the slots.

The walls move between two distinct extreme positions with respect to the disc working surface: one raised position, in which the walls are partially raised with respect to the disc working surface, so that they can pull the coins or tokens, and a lowered position, in which the walls are situated completely below the disc surface, so as to release the coins or tokens, and to pass beneath the deflecting member.

When in normal position, the walls are elastically urged outward by the spring means, so as to protrude from the disc surface.

The dispenser has also a coin ejecting arm, loaded by a spring and situated on the same inner wall

of the magazine chamber on which the rotating disc is situated. The coin ejecting arm is situated outside the magazine chamber.

The coins or tokens, conveyed by the walls, are deflected, by the deflecting member, to be delivered through the outlet slot.

However, also this type of dispenser has different disadvantages resulting from the structural complexity and the difficult assembling of various elements, in particular from the introducing of spring means into the slots and from the arrangement of the walls thereon.

### SUMMARY OF THE INVENTION

Therefore, the object of the present invention is to propose a new coin and/or token dispenser, aimed at being installed in an automatic distributor, paying device, coin changer, or slot machine, which are able to avoid various disadvantages, pointed out above and present in different known types of dispensers, described above.

In particular, the main object of the present invention is to propose a coin and/or token dispenser, which is capable of receiving, thereinside, any kind of coins or tokens, of minimum as well as of maximum dimensions, and of delivering them without any jam problem and avoiding a delivery of an incorrect quantity of coins or tokens, different from the pre-established or desired one.

A further object of the present invention is to propose a new coin and/or token dispenser, characterized by a structure, which is particularly functional and reliable, as far as the conveying modes of the various values and kinds of coins or tokens are concerned, by means of the rotating disc, and the delivery thereof; and by simple assembling of different elements constituting it.

The above mentioned objects are entirely obtained, in accordance with the contents of the claims, by a coin and/or token dispenser for automatic distributors or paying devices, including:

a chamber for receiving and depositing coins and/or tokens, the chamber having a first inner wall and a second inner wall;

a rotating disc mounted on the first inner wall, connected, by mutual coupling means, with motor means situated outside said chamber,

a working surface defined in said rotating disc and turned toward the chamber;

conveying means associated to said working surface for conveying single coins and/or tokens, said conveying means being provided for conveying and moving said single coins and/or tokens along a circular path due to rotation of said disc caused by said motor means;

a deflecting member, cantilevered to said second inner wall of said chamber above a circular section of said working surface, so as to involve said circular path of said coins and/or tokens and to contact and deflect said coins and/or tokens from said circular path radially outwards; an elastic member, situated external to the rotating disc, on the same first inner wall, near said deflecting member, for ejecting the coins and/or tokens and receiving the coins and/or tokens deflected by said deflecting member and for sending them to an outlet slot, situated on said first inner wall, in order to deliver said coins and/or tokens,

wherein said conveying means for conveying the coins and/or tokens include a plurality of rows of teeth, protruding from said working surface in a stationary configuration, said rows of teeth being also angularly spaced apart, so as to define therebetween corresponding seats, which receive respective single coins and/or tokens of said coins and/or tokens contained in said chamber, and with said teeth of each of said rows, being arranged radially, one after another, along a respective radius of said working surface and mutually spaced apart, so as to contact and move said single coins and/or tokens, due to rotation of the disc;

said deflecting member having a series of circular recesses, made in its face turned to the working surface of the rotating disc, said recesses being spaced apart and having such a profile, as to house freely the teeth of said rows of teeth, and make them translate thereinside, due to rotation of said rotating disc.

### BRIEF DESCRIPTION OF THE DRAWINGS

The characteristic features of the invention will be pointed out in the following, example and not limiting description with reference to the enclosed figures, in which:

FIG. 1 is a schematic and front perspective view of the coin and/or token dispenser for automatic distributors and paying devices, proposed by the present invention, while

FIG. 2 is a schematic, rear perspective view of the same dispenser;

FIG. 3 is a schematic and enlarged perspective view of particularly significant elements of the dispenser proposed by the present invention;

FIG. 4 is a section view, taken along the vertical section IV-IV shown in FIG. 2, in an enlarged scale;

FIG. 5 is a schematic view of a lateral face of the dispenser proposed by the invention, in which other significant elements of the dispenser are shown in a cutaway view;

FIG. 6 is a perspective, schematic and enlarged view of particularly significant elements of an embodiment of the proposed dispenser shown in FIG. 1;

FIG. 7 is an enlarged, section view, taken along the vertical section VII-VII pointed out in FIG. 2, of the embodiment of the dispenser.

### DETAILED DISCLOSURE OF THE PREFERRED EMBODIMENTS

With regards to the enclosed Figures, the reference E indicates the coin and/or token dispenser proposed by the present invention, as a whole.

The dispenser E is aimed at being installed in automatic distributors of goods or services, or in paying devices, coin changers, slot machines and/or in other similar apparatuses, which deliver coins or tokens.

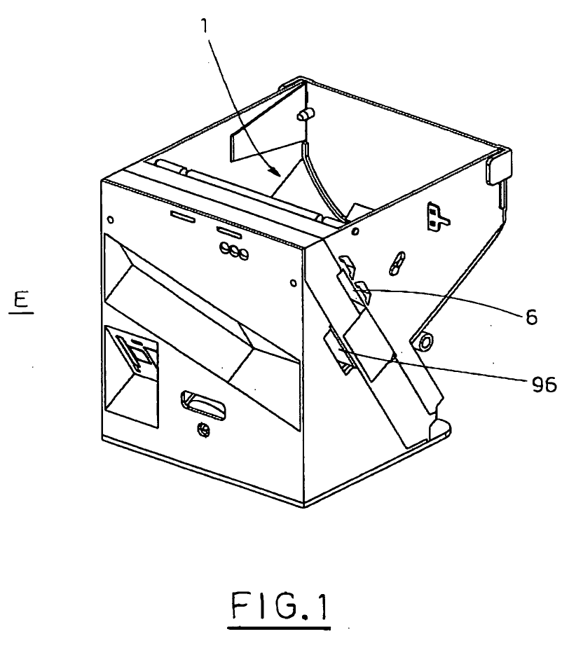

The dispenser E, as shown for example in a schematic way in FIG. 1, has a box-like structure so as to define thereinside a chamber 1 for receiving and storing coins and/or tokens, coming from a accumulation magazine.

The chamber 1 has a prismatic form with the lower base wall inclined downwards, the upper wall open, so as to receive the coins and/or tokens coming from the above mentioned magazine, and a first inner lateral wall 11, likewise slightly inclined toward the lower base and toward the inside of the chamber 1.

In this way, the coins and/or tokens present inside the chamber 1 accumulate near the lower part of the first inner wall 11, due to the gravity and because of the downward inclination of the lower base wall.

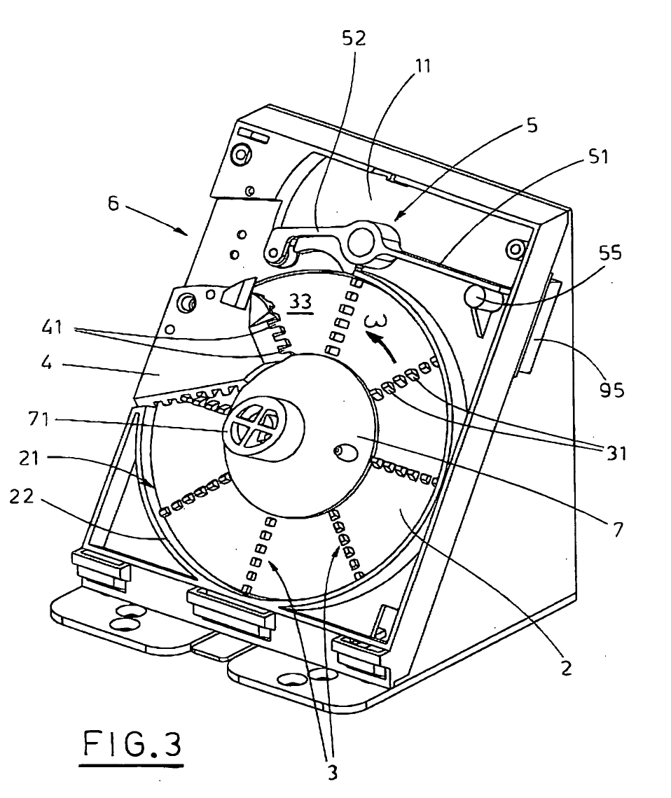

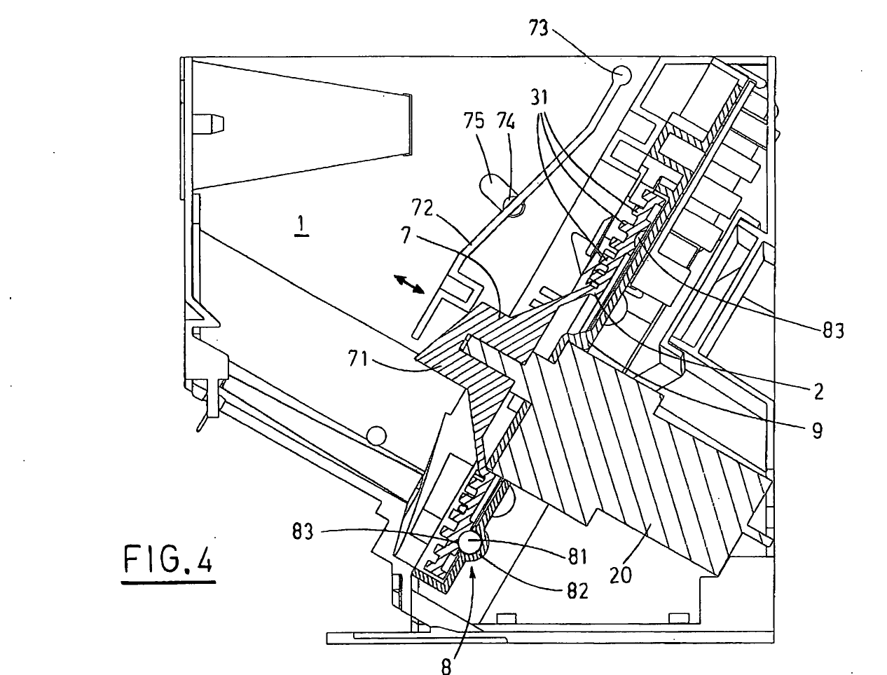

The dispenser E includes, as shown in detail in FIG. 3, a disc 2, which is mounted in a seat 21, made in the first lateral inner wall 11, and which rotates on its central axis, that is keyed coaxially on a motor member 20, situated outside of the chamber 1 (see in particular FIG. 4).

The rotating disc 2 has a working surface turned toward the inside of the chamber 1, which has conveying means 3 for single coins and/or tokens, which means are capable, as a consequence of the rotation of the disc 2, of conveying and moving single coins and/or tokens, situated near the first inner wall 11, along a circular path indicated with reference letter ω in FIG. 3.

The dispenser E includes also a deflecting member 4, cantilevered to a second lateral inner wall of the chamber 1, adjacent to the first wall 11, above a circular section of the working surface of the rotating disc 2 and near the first wall, so as to involve the circular path ω of the coins and/or tokens movement and to contact and deflect radially the coins and/or tokens, externally to the rotating disc 2.

For this purpose, the border 22 of the seat 21, inside which the disc 2 is introduced, has a gap in a region corresponding to, and next to the deflecting member 4.

In order to facilitate the ejection of the coins and/or tokens, so deflected by the deflecting member 4, the dispenser E has also an elastic member 5, which is situated externally to the rotating disc 2 on the first inner wall 11, near the gap of the border 22 and near the deflecting member 4.

The elastic member 5 is capable of receiving the coins and/or tokens, deflected radially outward of the disc 2, by the deflecting member 4, and of sending them out of the dispenser E through an outlet slot 6, situated near the same first inner wall.

A first distinctive feature, which characterizes and differences the dispenser E proposed by the present invention from the known dispensers, mentioned in the introductory note, lies in the fact that the means 3 for conveying the coins and/or tokens include a plurality of rows of teeth 31, protruding from the working surface of the rotating disc 2, in a fixed configuration.

The rows of protruding teeth 31 are angularly spaced apart one from another, so as to define therebetween, corresponding seats 33, which receive respective single coins and/or tokens out of the coins and/or tokens contained inside the chamber 1, near the lower part of the relative first inner wall 11.

The angular width and the radial extension of the seats 33 are such, as to allow the seats to contain thereinside coins and/or tokens of any dimensions, of minimum size (minimum diameter), as well as of maximum size (diameter).

Further, the teeth 31 of each row of protruding teeth are arranged radially, one after another, along a respective radius of the working surface of the disc 2 and distanced one from another, so as to form a kind of continuous wall, which contacts the edge of the coins and/or tokens introduced into the seats 33, and pulls the coins and/or tokens along the circular path ω, due to the rotation of the disc 2.

Another characteristic feature of the dispenser E proposed by the present invention, results from the fact that the deflecting member 4 has, made in its face turned to the working surface of the rotating disc 2, a series of circular recesses 41, spaced apart and having such a shape, as to house freely the teeth 31 of the rows of protruding teeth of the rotating disc 2, and to make them pass thereinside, as a consequence of the disc 2 rotation (FIG. 3).

In this way, the border of the deflecting member 4 strikes and deflects the coins and/or tokens conveyed by the protruding teeth 31, while the recesses 41 house thereinside the teeth 31, without creating any obstacle to their movement along the circular path ω.

The moving of the teeth 31 close to the deflecting member 4 reduces the angular width of the seat 33, containing the coin (or token), which has been contacted by the border of the deflecting member 4 and must be subjected to the radial deflection outwards with respect to the circular path ω, followed up to that moment.

This occurs because, one side of the coin (or token) is subjected to a constant and uniform push caused by a row of protruding teeth 31, which, as pointed out before, form a kind of continuous pushing wall, and the other side meets the fixed obstacle formed by the deflecting member 4.

Thus, the coin (or token) is deflected radially, without any jam possibility, out of the rotating disc 2 through the gap in the border 22 of the seat 21 of the disc.

For this purpose, the edge of the deflecting member 4, which contacts the coins and/or tokens has such a shape, as to facilitate the radial deflecting of the coins and/or tokens out of the disc 2.

The recesses 41, made in the face of the deflecting member 4 turned to the rotating disc 2, allow advantageously a continuous and uniform advancement of the protruding teeth 31, and, consequently, the disc 2 can rotate without the need of any particular and complicated constructive measures for making the conveying means for the coins and/or tokens disappear below the working surface of the rotating disc, which instead occurs in the known dispensers, mentioned in the introductory note.

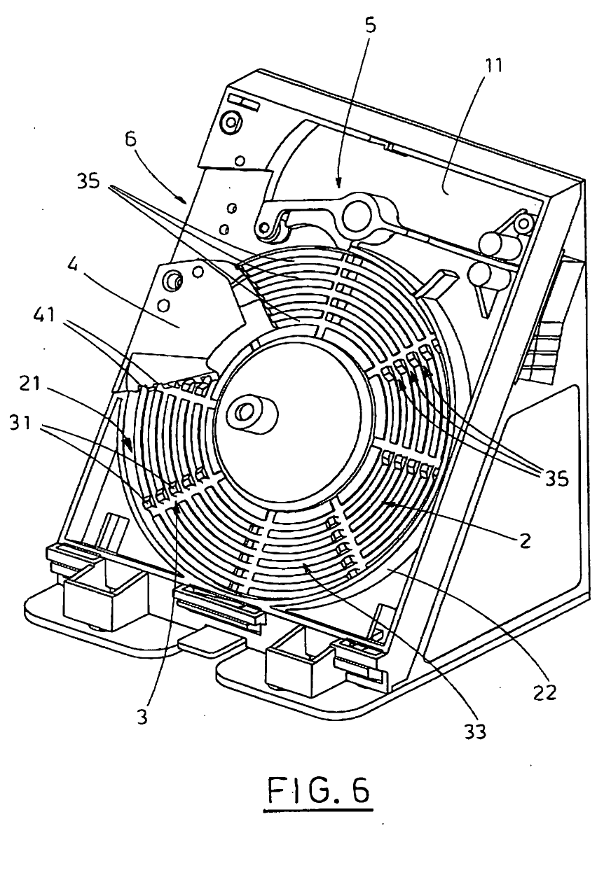

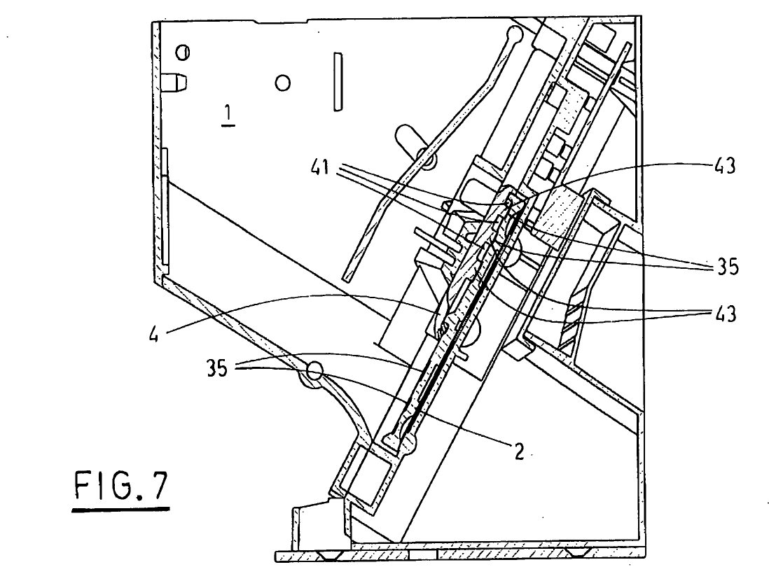

According to the embodiment shown in detail in FIGS. 6 and 7, the working surface of the rotating disc 2 can have a series of circular, concentric grooves 35, situated between the teeth 31.

At the same time, the deflecting member 4 has ledges 43, carried by the relative face turned toward the working surface of the rotating disc 2 and interposed between the relative adjacent recesses 41.

The ledges 43 follow a circular path, corresponding to the one of the grooves 35 of the rotating disc 2, and have such a profile as to engage with these grooves 35, without creating any friction.

This feature facilitates considerably the coins deviation operation, and avoids any possible jamming of the coin below the deflecting member 4, due to the coin reduced thickness.

Actually, the ledges 43 of the deflecting member 4, engaged with the grooves 35 of the disc 2, penetrate slightly below the working surface of the latter, thus forming, in a sure way, abutments, which cannot be missed by the coins, which are deflected without any possibility to enter the space below the deflecting member 4.

FIG. 7 is a detailed section view of the deflecting member 4, which shows both the recesses 41 and the ledges 43 of the deflecting member 4, together with a portion of the rotating disc 2, in order to point out the grooves 35 of the latter.

Other characteristic features of the dispenser E proposed by the present invention are described in the following.

The rotating disc 2 is keyed onto the motor means 20, coaxial therewith, and is supported by a fixed disc 9, by means of centering and balancing means 8.

The disc 9 is connected to the motor means 20, situated externally to the first inner wall 11 of the chamber 1, in correspondence to the seat 21.

As it is shown in detail in FIG. 4, the centering and balancing means 8 include a plurality of small spheres 81, which are received in relative semi-spherical seats 82, made on the surface of the fixed disc 9 turned toward the first inner wall 11, along the same circumference.

The small spheres 81 are aimed at engaging with a relative circular groove 83, made in the surface of the rotating disc 2 turned to the fixed disc 9.

In this way, when the rotating disc 2 is rotated by the motor means 20, it is constantly centered and balanced with respect to the fixed disc 9.

The dispenser E has a frusto-conical cap 7, mounted coaxially on the working surface of the rotating disc 2, whose lower base delimits the seats 33 for receiving the coins and/or tokens.

This prevents the coins and/or tokens introduced into the respective seats 33 and rotated by the protruding teeth 31, from falling, while following the circular path ω, to the base of the chamber 1, before reaching the deflecting member 4.

The upper end of the frusto-conical cap 7 is surmounted by a skew-ended cylindrical element 71, which carries a plate 72, housed inside the chamber 1.

The upper end of the plate 72 is pivoted in 73 to the upper part of the second inner lateral wall of the chamber 1 and to the upper part of a third inner lateral wall of the same chamber, opposite to the second wall. The plate 72 is also constrained by means of related pins 74, fastened to opposite lateral edges thereof, to slots 75, made on the second wall and on the third wall, so that it can oscillate.

Therefore, due to the rotation of the disc 2, the plate 72 is driven by the skew-ended element 71 into alternate oscillation inside the chamber 1, so as to stir and mix the mass of coins and/or tokens present inside the chamber 1, and to facilitate their uniform distribution thereinside.

The elastic member 5 for ejecting coins and/or tokens advantageously includes, in one body, an arm 52, pivoted to the first inner wall 11 in a region corresponding to the border 22, and an elastic loading laminar element 51, opposite to the arm 52 with respect to the fulcrum and fastened to a stationary support 55, made on the same first inner wall 11.

The dispenser E includes also means 60 for detecting and identifying the delivery of coins and/or tokens, which are situated in a position corresponding to the outlet slot 6, facing the latter (FIG. 5).

The detecting means 60 include light radiation emitting diodes (LEDs) and sensor diodes for receiving light radiations, situated on a first border of the outlet slot 6, and reflecting means (e.g. prismatic elements refracting and reflecting light radiations), which are situated in a position corresponding to a second border, opposite to the first border, of the outlet slot 6.

The reflecting means are capable of reflecting the light radiations emitted by the light emitting diodes and passing through the slot 6, toward the receiving diodes, so that the light radiation passes again through the outlet slot 6.

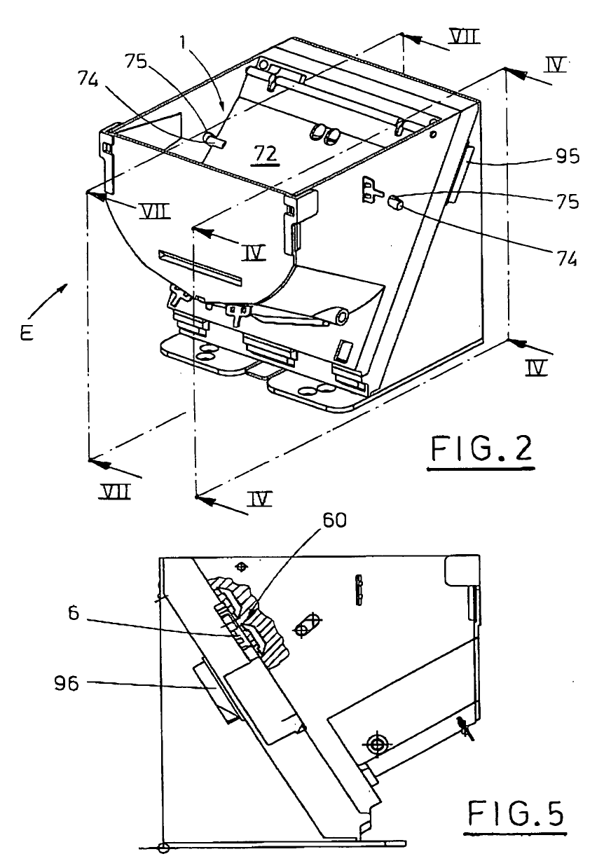

Finally, the dispenser E includes, as shown in FIGS. 1, 2 and 3, a first additional slot 95 for insertion of coins and/or tokens, situated on a first lateral wall, outside of the chamber 1, a second additional slot 96 for releasing of coins and/or tokens, situated on a relative second lateral wall, on which the coin outlet slot 6 is situated, opposite to the first lateral wall and outside the chamber 1, and an inner channel, in which the coins and/or tokens slide, and which extends from the first additional slot 95 to the second additional slot 96.

The inner sliding channel is aimed at receiving coins and/or tokens coming from another dispenser: in this way, the second lateral wall of the dispenser E can deliver coins and/or tokens coming from more dispensers, and consequently, of different values and types.

It appears from what has been previously described and pointed out that the dispenser E proposed by the present invention is capable of housing in its inside coins and/or tokens, and of delivering the required and desired quantities thereof, of different types and dimensions, without any risk of coins and/or tokens jamming or of jamming of the rotating disc 2 rotation.

Further, the dispenser E has a structure, whose elements are easy to assemble, and which is particularly functional and reliable in relation to the requested performance.

It is understood that the proposed invention has been described, with reference to the enclosed figures, as a mere, not limiting example. Therefore, it is obvious that any changes or variants suggested by the practice and its use, can be applied thereto and remain within the protective scope defined by the following claims.

What is claimed is:

1. A coin and/or token dispenser for automatic distributors or paying devices, including:
a chamber for receiving and depositing coins and/or tokens, the chamber havinq a first inner wall and a second inner wall;
a rotating disc mounted on the first inner wall, connected, by mutual coupling means, with motor means situated outside said chamber,
a working surface defined in said rotating disc and turned toward the chamber;
conveying means associated to said working surface for conveying single coins and/or tokens, said conveying means being provided for conveying and moving said single coins and/or tokens along a circular path due to rotation of said disc caused by said motor means;
a deflecting member, cantilevered to said second inner wall of said chamber above a circular section of said working surface, so as to involve said circular path of said coins and/or tokens and to contact and deflect said coins and/or tokens from said circular path radially outwards;
an elastic member, situated external to the rotating disc, on the same first inner wall, near said deflecting member, for ejecting the coins and/or tokens and receiving the coins and/or tokens deflected by said deflecting member and for sending them to an outlet slot, situated on said first inner wall, in order to deliver said coins and/or tokens,
wherein said conveying means for conveying the coins and/or tokens include a plurality of rows of teeth, protruding from said working surface in a stationary configuration, said rows of teeth being also angularly spaced apart, so as to define therebetween corresponding seats, which receive respective single coins and/or tokens of said coins and/or tokens contained in said chamber, and with said teeth of each of said rows, being arranged radially, one after another, along a respective radius of said working surface and mutually spaced apart, so as to contact and move said single coins and/or tokens, due to rotation of the disc;
said deflecting member having a series of circular recesses, made in its face turned to the working surface of the rotating disc, said recesses being spaced apart and having such a profile, as to house freely the teeth of said rows of teeth, and make them translate thereinside, due to rotation of said rotating disc.

2. The dispenser of claim 1, wherein the working surface of said rotating disc includes a series of circular, concentric grooves, extending between the teeth of said rows of teeth, and in that said deflecting member includes a corresponding series of ledges, situated on its surface turned to the working surface of said rotating disc, and interposed between adjacent recesses, having a circular profile, corresponding to the one of said grooves.

3. The dispenser of claim 2, wherein said ledges have such a profile, as to engage, freely and without creating any friction, with the grooves of said rotating disc, slightly penetrating below the working surface of the latter, so as to facilitate the deflecting of the coins and/or tokens toward the elastic member and to avoid the introduction, and the consequent jamming, of the coins below said deflecting member.

4. The dispenser of claim 1, wherein said rotating disc is keyed in coaxial relation onto said motor means and is supported, by means of centering and balancing means, by a stationary disc connected to said motor means.

5. The dispenser of claim 4, wherein said centering and balancing means include a plurality of small balls, which are introduced into housings made on the stationary disc along a unique circumference, and engaging with a circular groove made on a surface of the rotating disc opposite to said working surface.

6. The dispenser of claim 1, wherein said rotating disc is housed inside a relative seat made in said first inner wall delimited by a relative annular border, with a gap in a position corresponding to said deflecting member and to said ejection member.

7. The dispenser of claim 6, wherein said rotating disc is keyed in coaxial relation onto said motor means and is supported, by means of centering and balancing means, by a stationary disc connected to said motor means.

8. The dispenser of claim 7, wherein said centering and balancing means include a plurality of small balls, which are introduced into housings made on the stationary disc along a unique circumference, and engaging with a circular groove made on a surface of the rotating disc opposite to said working surface.

9. The dispenser of claim 1, further including a frusto-conical cap, mounted coaxially on the working surface of the rotating disc with a base delimiting said seats for receiving the coins and/or tokens.

10. The dispenser of claim 9, wherein the upper end of said frusto-conical cap is surmounted by a skew-ended cylindrical element, which carries a plate pivoted to an upper border of the second inner lateral wall and to a third inner lateral wall of said chamber, opposite to said second wall, so as to involve the inside of said chamber, said plate being provided with pins fastened to lateral edges and running into slots made in the second wall and in the third inner wall, so that, due to the rotation of the rotating disc, said plate is driven by said skew-ended element into oscillation inside said chamber, to stir the mass of coins and/or tokens present thereinside, and to facilitate their uniform distribution thereinside.

11. The dispenser of claim 1, wherein said elastic ejection member includes, in one body, an arm pivoted to said first inner wall and an elastic loading laminar element of said arm, opposite to the arm with respect to the fulcrum and fastened to a relative stationary support, made on said first inner wall.

12. The dispenser of claim 1, further including means for detecting the delivery of coins and/or tokens, associated and facing said outlet slot.

13. The dispenser of claim 12, wherein said detecting means include light radiation emitting diodes and light radiation receiving diodes, situated beside a first border of said outlet slot, and reflecting means, situated beside a second border, opposite to the first border of said outlet slot, so as to reflect light radiation emitted by the emitting diodes toward the receiving diodes.

14. The dispenser of claim 1, further including a first additional slot, for insertion of coins and/or tokens, situated in a first lateral wall, outside said chamber, and a second additional slot, for releasing of coins and/or tokens, situated in a second lateral wall, in which said coin outlet slot is situated, opposite to said first lateral wall and outside of said chamber, and an inner channel, in which the coins and/or tokens slide, extending from said first additional slot to said second additional slot, said inner sliding channel receiving coins and/or tokens coming from another dispenser, situated beside said dispenser.
